(19) United States
(12) Patent Application Publication
(10) Pub. No.: US 2021/0195928 A1
(43) Pub. Date: Jul. 1, 2021

(54) NOVEL THICKENING COMPOSITIONS BASED ON STARCH

(71) Applicant: Archer Daniels Midland Company, Decatur, IL (US)

(72) Inventors: Ali Ayoub, Decatur (LB); Baljit Ghotra, Champaign (CA); Joe Richardson, Decatur, IL (US)

(21) Appl. No.: 16/071,593

(22) PCT Filed: Jun. 6, 2017
(86) PCT No.: PCT/US17/36049

§ 371 Date: Jul. 20, 2018

Related U.S. Application Data
(63) Continuation of application No. PCT/US17/14934, filed on Jan. 25, 2017.
(60) Provisional application No. 62/286,643, filed on Jan. 25, 2016.

(51) Int. Cl. A23L 11/00; A23L 33/00; A23L 29/262; A23L 29/212; A23L 29/269

(52) U.S. Cl. CPC A23L 11/05; A23L 33/30; A23L 29/273; A23L 29/212; A23L 29/262

(57) ABSTRACT

Dysphagia patients face a number of challenges nutritionally because of their difficulty swallowing. Certain foods may be avoided altogether for fear of choking, and liquids are often avoided for fear of aspiration, so that dysphagia patients are at risk for both malnutrition and dehydration. Despite the technology of food administration to patients, there is a need to have a composition that can effectively alleviate patient swallowing difficulty and provide convenient, quick last minute meals for dysphagia patients that delivers nutrition. The invention concerns the use of a composition comprising a homogenized, comminuted pulse product, and at least one selected from the group consisting of a chemically unmodified starch and a hydrocolloid for the treatment of a patient having dysphagia.

### CROSS-REFERENCE TO RELATED APPLICATIONS

The present application claims priority of co-pending PCT Application No. PCT/US17/14934, filed Jan. 25, 2017, which itself claims priority to United States Provisional Application Serial No. 62/286,643, filed Jan. 25, 2016, each of the contents of the entirety of which are incorporated by this reference.

### TECHNICAL FIELD

The present invention relates generally to food technology and more particularly, to food products produced from pulses.

### BACKGROUND

Dysphagia is difficulty with swallowing and may be caused by old age and related health complications (i.e., dementia) or by certain medical conditions, such as stroke, neurological related disease, head/neck/spinal injury, Parkinson's disease, multiple sclerosis, Alzheimer's or other medical conditions. Dysphagia is a life-threatening medical condition that is thought to affect up to 219 million persons worldwide, including 15 million in the United States, where up to 1 million dysphagia patients are hospitalized each year.

Dysphagia patients face a number of challenges nutritionally because of their difficulty swallowing. Certain foods may be avoided altogether for fear of choking, and liquids are often avoided for fear of aspiration, so that dysphagia patients are at risk for both malnutrition and dehydration. While the foods those without dysphagia consume without difficulty (for example, meats) can feasibly be pureed to a degree whereby they can be safely consumed, nevertheless, the end product is dramatically altered from the patient's former experience of those foods and as a result is frequently unappetizing to the dysphagia patient. Many patients reduce or alter their oral intake of food and/or liquids, which, in turn, can contribute to lowered nutritional status. This can be especially problematic and can contribute to malnutrition, and malnutrition can further contribute to decreased functional capacity.

Consequently, there have been consistent, ongoing efforts toward the development of improved nutritional compositions that can provide, in a small volume, all necessary nutritional requirements in an easy to swallow form, but that also meet the aesthetic requirements of dysphagia patients. One persistent difficulty encountered in the course of these efforts has been producing a liquid composition with a reliable, durable (processing, shelf and storage stable) viscosity that lends itself to being easily swallowed without fear of either choking or aspiration, and particularly such a liquid composition which further contains a high content of intact proteins from a major, readily accessible protein resource in an aesthetically acceptable form.

Dysphagia management by current products that are commercially available includes thickening powder and pre-thickened liquids. Powder products include THICK-IT® by Precision Foods, USA, THICKEN UP® by Nestle Nutrition, USA, and THICK & EASY® by Hormel Healthlabs, USA. Pre-thickened liquids are available from THICK & EASY® (Hormel Healthlabs, Austin, Minn. USA), and RESOURCE® Nestle, USA. While there are a number of commercially available thickeners used currently for the treatment of dysphagia, significant drawbacks are exhibited that negatively affect acceptability and compliance in patient use. Fundamental components of such commercially available starch or gum based thickeners are chemically modified starches, which consumers perceive as unnatural. Further, when modified starches are used as a thickener, they have shown inconsistent viscosity over time, which may in turn lead to an increased danger of choking and aspiration of liquids or food particles into the lung.

In addition, unfortunately, starch also has several serious inherent problems that limit its usefulness in the management of dysphagia. Starch is an easily digested carbohydrate and adds calories to diets, and is thereby undesirable for use with those who are on calorie restrictions or are diabetic. A native starch-based composition would not have stability characteristics. Other solutions similarly have not been entirely satisfactory. Despite the technology of food administration to patients, there is a need to have a composition that can effectively alleviate patient swallowing difficulty and provide convenient, quick last minute meals for dysphagia patients that delivers nutrition.

### SUMMARY OF THE INVENTION

In each of its various embodiments, the present invention fulfills these needs and discloses methods of treating patients having dysphagia.

In one embodiment, a method of treating a patient having dysphagia comprises feeding a homogenized, comminuted pulse product to the patient.

In another embodiment, a method of providing nutrition to a patient suffering from dysphagia includes administering to the patient a composition comprising a homogenized, comminuted pulse product in combination with an least one hydrocolloid.

In a further embodiment, a method of treating having dysphagia comprises feeding a homogenized, enzyme treated, comminuted pulse product to the patient.

In yet a further embodiment, a composition comprises from about 5 wt % to about 70 wt % of a homogenized, comminuted pulse product, from about 20 wt % to about 70 wt % starch, from about 5 wt % to about 40 wt % dextrin, and from about 2 wt % to about 30 wt % of a hydrocolloid. Uses of the compositions of the present invention for treating dysphagia are also disclosed.

In another embodiment, a method of providing nutrition to a patient suffering from dysphagia comprises mixing a nutritional supplement with the composition of the present invention, thus forming a nutritional product, and administering the nutritional product to the patient.

### DESCRIPTION OF THE DRAWINGS

FIG. 1 discloses one embodiment of a process of producing a pulse product of the present invention.

FIG. 2 discloses the viscosity of slurries containing various embodiments of the pulse products of the present invention.

FIG. 3 depicts the total sugar content and total DP2-DP10+ content of various pulse products produced using the present invention.

FIG. 4 shows the viscosity of slurries containing various embodiments of the 20 pulse products of the present invention at different temperatures.

FIG. 5 illustrates the viscosity of slurries containing various embodiments of the pulse products of the present invention.

### DETAILED DESCRIPTION OF CERTAIN EMBODIMENTS

The disclosures of all patent and non-patent literature referenced herein are hereby incorporated in their entireties.

“Dysphagia” as used herein refers to diagnosed abnormalities, such as difficulties, in the swallowing process.

“Starch” is a polysaccharide carbohydrate found in various natural resources including but not limited to corn, maize, rice, wheat, tapioca, and potato, For example, a suitable starch is a maize starch (e.g. ADM ® Pregel 100). The term “native starch” is intended herein to mean any starch that possesses starch granules and has not been thermally or chemically modified. Due to the diversity in structure and function, such as water solubility, instability of paste under acid conditions, heating and shearing reactions, refrigeration, and pressure, native starches have been pushed aside by modified starches that better withstand these rigors of modern food processing techniques.

“Modified starch” as used herein refers to starch having been subjected to a modification process. Modification can be a physical process such as heat, pregelatinization, or moisture treatment or chemical processes such as enzyme or alkali treatment, oxidation/bleaching, hydrolysis, partial hydrolysis or derivatization processes such as etherification, esterification, cross-linking, and combinations thereof.

“DE” is defined as the reducing power of starch substance. Each starch molecule has one reducing end; therefore DE is inversely related to molecular weight. The DE of anhydrous D-glucose is defined as 100 and the DE of unhydrolyzed starch is virtually zero.

“Pulses,” also referred to as legumes, as used above and elsewhere herein shall be understood to include edible beans, lentils, and peas. Other pulses not listed herein can likewise be used.

“Pulse products” as used herein shall be understood to include products that are functional as a food ingredient, yet provides the nutritional value of pulses. Pulse products and methods for preparation are well known in the art, for example in U.S. Pat. Nos. 5,435,851, 5,916,624, 4,363,824, and 4,667,653, the disclosures of which are incorporated by reference in their entirety. Methods of preparing “pulse products” are also described in such articles as “Agglomeration of Food Powder and Applications” by K. Dhanalakshmi , S. Ghosal & S. Bhattacharya (2011) Critical Reviews in Food Science and Nutrition, 51:5, 432-441 and “Bioactive proteins and peptides in pulse crops: Pea, Chickpea, and Lentil” by F. Roy, J.I. Boye and B.K. Simpson (2010) Food Research International, 43, 2, 432-442, incorporated by reference in their entirety. Processes include batch or continuous cooking, acid or base treatment, and then drying. The term “drying” refers herein to any drying method, such as turbo drying, heat drying, spray drying, drum drying, vacuum drying, and any combination thereof.

“Hydrocolloids” generally are of vegetable, animal, microbial, or synthetic origin that can provide a number of different functions when used in various food and chemical applications. For example, hydrocolloids provide excellent emulsifying, thickening and gelling characteristics. Hydrocolloids readily absorb water thus increasing the systems viscosity and thereby impart a smoothness to the texture of most products, even when used in very small amounts. Most are comprised of carbohydrate polymers containing many hydroxyl groups but a few such are proteins.

The “dextrin” used is a polymeric hydrophilic compound, being a glucose polymer, with a dextrose equivalent (DE) of less than 20, preferably a maltodextrin with DE not higher than 16, more preferably with DE of from 5 to 15 is applied.

In the context of this disclosure, “xanthan gum” is food grade and can be commercially obtained from numerous suppliers. The term “xanthan” used throughout this disclosure is xanthan gum. Xanthan gum is a high molecular weight, long chain polysaccharide composed of the sugars glucose, mannose, and glucuronic acid. The backbone is similar to cellulose, with added side chains of trisaccharides.

The term “thickening composition” as used herein refers to a composition suitable to thicken various nutritional products and supplements. As employed herein, “thickened liquid” includes a liquid in appearance, entirely or in part based on water, a liquid nutrient, food containing unbound liquid, liquid medication or food that is made thicker by the addition of a thickening composition. These compositions and thickened liquids may have a thin, nectar, honey, or spoon-thick liquid consistency. These consistencies are to be understood as defined by standards for the dysphagic diet, published in

October 2002 by American Dietetic Association (“National Dysphagia diet”, NDD). For example, four levels of liquid viscosity are proposed and labeled “thin”, “nectar-thick”, “honey-thick” and “spoon-thick” and corresponding to apparent viscosity ranges of 1-50, 51-350, 351-1,750, and >1,751 centipoise (cps), measured at a shear rate of 50/s

The term “enzyme treated” as used above and elsewhere herein shall be understood to include treatment with an enzyme having amylase activity or a combination of amylase and xylanase activity.

The term “comminuted” is used herein shall be understood to mean reduced to minute particles or fragments.

The term “homogenized” as used herein shall be understood to mean to make uniform or similar.

Several aspects and properties are of crucial importance in order to arrive at a food product that provides successful consumption by and proper nutrition of dysphagia patients. First, the viscosity and feel of the food product is very important. Before consumption, dysphagia patients expect that the product is thickened properly and has the right viscosity. Secondly, food products must retain the right viscosity during preparation and consumption. The patient must feel confident when consuming the product, that the product retains a stable viscosity.

Therefore, in one embodiment of the present invention a product that combines the properties of a good dispersibility and cohesiveness, good viscosity profile and a good stability is disclosed. The inventors surprisingly found that it is possible to prepare nutrient-dense compositions that have a stable viscosity in order to make it a suitable product for dysphagia patients. Further, the present disclosure is to provide methods of treating a patient with dysphagia using compositions, thickened liquids, and nutritional products for convenient, quick last minute meals. More in particular, the invention concerns the use of a composition comprising a homogenized, comminuted pulse product, and at least one selected from the group consisting of a chemically unmodified starch and a hydrocolloid for the treatment of a patient having dysphagia.

The methods and compositions herein apply to treatment of a patient and any mammal, including small domesticated animals, particularly companion animals and pets, including but not limited to, mice, rats, hamsters, guinea-pigs, rabbits, cats, dogs, and primates. Patients in need of the treatments described herein have been diagnosed with dysphagia, or may have signs of dysphagia. Accordingly, the “patient” refers to any animal, mammal or patient having or at risk for dysphagia that can benefit from the treatment.

As used in this application, the singular forms “a”, “an” and “the” include plural references unless the context clearly indicates otherwise. The term “comprising” and its derivatives, as used herein, are similarly intended to be open ended terms that specify the presence of the stated features, elements, components, groups, integers, and/or steps, but do not exclude the presence of other unstated features, elements, components, groups, integers and/or steps. This understanding also applies to words having similar meanings, such as the terms “including”, “having” and their derivatives. The term “consisting” and its derivatives, as used herein, are intended to be closed terms that specify the presence of the stated features, elements, components, groups, integers, and/or steps, but exclude the presence of other unstated features, elements, components, groups, integers, and/or steps. Terms of degree such as “substantially”, “about” and “approximately” as used herein mean a reasonable amount of deviation of the modified term (beyond that degree of deviation understood by the precision (significant figures) with which a quantity is expressed) such that the end result is not significantly changed. These terms of degree should be construed as including a deviation of at least plus or minus five (5) percent from the stated value, provided this deviation would not negate the meaning of the term modified.

In the context of this invention, starch is a food grade starch that can be commercially obtained from numerous suppliers. Besides starch from corn, suitable starches may be rice-, wheat-, and tapioca starch. For example, a suitable starch is a maize starch (e.g. ADM ® Pregel 100). The dextrin used is a polymeric hydrophilic compound, maltodextrin, being a glucose polymer, with a dextrose equivalent (DE) of less than 20, preferably a dextrin with DE not higher than 16, more preferably with DE of from 5 to 15 is applied. In the context of this disclosure, xanthan gum is food grade and can be commercially obtained from numerous suppliers. Xanthan gum is a high molecular weight, long chain polysaccharide composed of the sugars glucose, mannose, and glucuronic acid. The backbone is similar to cellulose, with added side chains of trisaccharides.

The present invention may be more completely understood by describing certain embodiments in greater detail. These embodiments are not to be taken as limiting the scope and breadth of the current invention as more particularly defined in the claims that follow, but are illustrative of the principles behind the invention and demonstrate various ways and options for how those principles can be applied in carrying out the invention.

Thus, unless otherwise indicated, any definitions or embodiments described in this or in other sections are intended to be applicable to all embodiments and aspects of the subjects herein described for which they would be suitable according to the understanding of a person of ordinary skill in the art.

In an embodiment, the comminuted pulse product may be produced using the process described in PCT Application No. PCT/US17/14934 assigned to Archer Daniels Midland Company of Decatur, Ill., entitled Improved Pulse Processing and Products Produced Therefrom, the contents of the entirety of which is incorporated by this reference.

In one embodiment, the pulse may be beans of a Phaseolus species, beans of a Vigna species, beans of Vicia species, peas, chickpeas, lentils, and combinations of any thereof.

In a further embodiment, the homogenized pulse product may be produced from an edible bean of a Phaseolus species. In other embodiments, the pulse product may be produced from green or yellow peas (i.e., Pisum), green, red, or yellow lentils (i.e., Lens vulgaris), chickpeas or garbanzos, (i.e., Cicera arietenum), and combinations of any thereof. In further embodiments, varieties of beans that may be used to produce the pulse products of the present invention include, without limitation, Pinto beans, Great Northern beans, Navy beans, Red beans, Black beans, Black Turtle beans, dark or light

Red Kidney beans, Fava beans, Green Baby Lima beans, Pink beans, MYASI beans, Mayocoba beans, Yellow beans, Peruvian beans, Small Red beans, Black Eyed beans, Cow peas, Garbanzo beans, Cranberry beans, White Beans, Rice beans, Butter beans, Pea beans, African Giraffe beans and any combinations thereof.

In each of its various embodiments, the present invention discloses a method of providing nutrition to a patient suffering from dysphagia.

In one embodiment, a method of treating a patient having dysphagia, comprises feeding a homogenized, comminuted pulse product to the patient having dysphagia.

In a further embodiment, the homogenized, comminuted pulse product is enzyme treated.

In a further embodiment, the method of providing nutrition to a patient suffering from dysphagia, comprises administering to the patient in need thereof a composition, comprising a homogenized, comminuted pulse product in combination with at least one hydrocolloid.

In one embodiment, the amount of homogenized, comminuted pulse product employed will depend greatly on the specific thickener chosen and its specific thickening properties to be achieved in the thickened liquid.

In a further embodiment, the thickened liquid will be completely thickened at the desired thickness and ready to provide nutrition to a patient suffering from dysphagia. Advantageously, the thickened liquid will maintain its consistency and stability on standing. In essence, the thickened liquid is ready to be administered to the patient in need thereof.

In yet a further embodiment, the invention concerns a thickening composition for thickening nutritional supplements to make the nutritional product suitable for consumption by dysphagia patients.

In further embodiments of the invention, a thickening composition is incorporated into a nutritional supplement to enhance dispersibility and maintain its stability and consistency. A family of supplements commonly found in North America is sold under the name ENSURE by Ross Laboratories. Another family which is commercially available is sold under the name RESOURCE by Novartis Nutrition Ltd and yet another family which is commercially available is sold under the name NUBASICS by Nestlê Clinical Nutrition.

Also, the invention relates to a method for preparing a thickened nutritional product comprising the steps of mixing the thickening composition according to the present invention with a food product. Food products that may be used for preparing a thickened nutritional product of the present invention include dessert-type instant food products such as yogurt, pudding, icings, dips, dairy products such as sherbet, frozen yogurt, frozen custard, popsicles, sorbet, gelato, or combinations thereof, gels, soups, dips, batter, baby foods, spreads such as peanut and cheese spreads, and the like, custards, cheese/cheese imitation, and beverages.

In still a further embodiment, the thickening composition is an effective thickener for liquid foods.

Further, the present invention relates to the development of novel thickening compositions, for use in providing nutrition to a patient suffering from dysphagia.to better and more completely meet all of their needs. In an embodiment, the thickening composition comprises, based on the total dry weight of the product, 5-70 wt % HET, 20-70 wt % starch, 5-40% maltodextrin, and 2-30 wt % xanthan gum.

One embodiment of the thickening composition according to the invention is as follows, based on the dry weight of the composition:

| | | | Alternatively | |
|---|---|---|---|---|
| HET | 5-70 | wt % | 10-40 | wt % |
| Starch | 20-70 | wt % | 30-50 | wt % |
| Maltodextrin | 5-40 | wt % | 10-30 | wt % |
| Xanthan gum | 2-30 | wt % | 5-10 | wt % |

The thickening composition may be free from starch, and have any desired viscosity achieved by, for example, blending various quantities of comminuted pulse product, gums, maltodextrin, or combinations of any thereof. In one embodiment, HET, xanthan gum and/or maltodextrin are in total more than 80 wt % of the dry weight of the thickening composition.

In one embodiment, in the use and compositions of the present invention, xanthan gum is selected. In another embodiment, maltodextrin is selected, and in yet a further embodiment, xanthan gum and maltodextrin are selected.

The use and compositions of the present invention may be prepared using methodology that is well known by an artisan of ordinary skill. It is to be understood that wherever values and ranges are provided herein, all values and ranges encompassed by these values and ranges, are meant to be encompassed within the scope of the present invention. Moreover, all values that fall within these ranges, as well as the upper or lower limits of a range of values, are also contemplated by the present application.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. For example, the thickening composition of the invention may also comprise additional ingredients, such as flavorants, vitamins, and any other food-stuff used in the field. While the invention is demonstrated herein using Navy beans, the invention is applicable to other pulses, beans and legumes as well.

The present invention is more particularly illustrated by the examples and comparative examples which follow:

### EXAMPLES

The methods disclosed herein are illustrated in the following examples. From the above discussion and these examples, one skilled in the art can ascertain the essential characteristics of this invention, and without departing from the spirit and scope thereof, can make various changes and modifications of the invention to adapt it to various uses and conditions.

All commercial reagents were used as received. ADM ® Pregel 100, maize starch (CAS number 9005-25-8), maltodextrin (Clintose TM CR 10) and xanthan gum were obtained from ADM (Decatur Ill.). The homogenized, enzyme treated (HET) Navy bean product was produced according to the embodiment of the present invention. The amylase was CLARASE L brand alpha amylase available from

DuPont. The xylanase was ROHALASE SEP brand xylanase available from AB Enzymes. The nutritional supplement, ENSURE, was obtained from Ross Laboratory.

The following abbreviations are or may be used in the examples: “RPM” mean revolutions per minute; “cps” means centipoise; “° C.” means degrees Celsius; “DE” means dextrose equivalent; “mL” means milliliter; “psi” means pounds per square inch; “HET” means homogenized, enzyme treated, comminuted pulse product; “wt %” means the dry weight of a particular component per total dry weight; “h” and “hr” means hours; “min” means minutes; “s” means seconds; and “g” means grams.

### Example 1

A pre-cooked, dehydrated Navy bean powder was mixed with water to produce a slurry at 20% weight/weight of the Navy bean powder. The Navy bean slurry was homogenized by being pumped through a GEA-Niro Souvi homogenizer at 8,000-10,000 psi. The homogenized Navy bean slurry was collected in containers. An enzyme (alpha-amylase) was added to the homogenized Navy bean slurry at a 0.04% dosage and allowed to incubate at about 70° C. for about 90 minutes.

After the homogenized Navy bean and enzyme slurry incubated, the slurry was heated to a temperature of greater than 75° C. (e.g., about 76° C.) and mixed for one hour to inactivate the alpha-amylase enzyme. The enzyme may also be inactivated by jet cooking the slurry at about 93° C. for one minute. The slurry was transferred to a sterile, jacketed surge tank and maintained at a temperature of about 50° C., during which time the slurry was pumped into a spray drier to produce a powdered product (HET) having a moisture content of about 9.1%. The spray drier had an inlet temperature of about 511° F. and an average outlet temperature of about 193° F.

### Example 2

Homogenized, enzyme treated pulses (HET) were produced by cracking raw

Navy beans in a cracker, thus producing Navy bean grits. The Navy bean grits were placed in 90° C. water in a Likwifier blender and blended. The blended Navy bean grits were placed in an in-line shear mixer and re-circulated in the blender for no more than 45 minutes. The blended Navy bean grits may have 10-15% total solids at this point.

The sheared/blended Navy beans were jet cooked with steam at 221° F. for between about 2-4 minutes. The jet cooked Navy beans were passed through a chill tank to trim cool the jet cooked Navy beans to about 70-80° C. The cooled, jet cooked Navy beans were passed into a GEA brand NS3006L Panther homogenizer and homogenized at 10,000 PSI (about 800 bar). The homogenizer may also be a GEA brand Niro Soavi homogenizer. The homogenized Navy beans were transferred to a cooling jacket and cooled to about 47-53° C. The cooled, homogenized Navy beans were placed in a tank along with amylase and xylanase and incubated with agitation at about 55-57° C. for a minimum of about 45 minutes, or a time of about 1.5 hours. The enzyme treated Navy beans were transferred back to the homogenizer and homogenized. The enzyme treated, homogenized Navy beans were placed in a vessel and jet cooked at about 195° F. for no more than 4 minutes to de-activate the enzymes. The Navy beans were passed through a 150 micron sock filter into a hold tank jacketed with 70° C. water. The act of passing through the filter may be optional. The Navy bean slurry was spray dried at about 800° F. in a spray drier with an outlet temperature of about 194° F. to yield the homogenized, enzyme treated (HET) Navy beans.

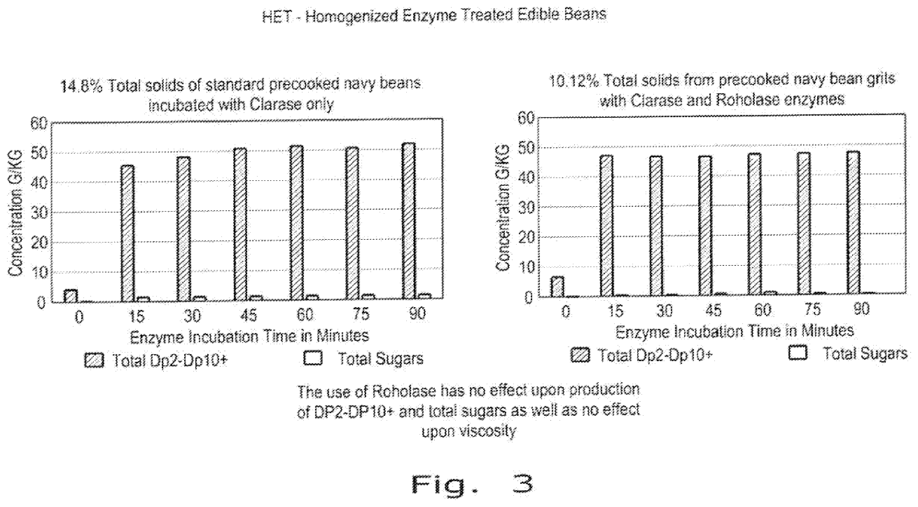

Viscosities of the homogenized, enzyme treated Navy beans were determined at various points during the process of Example 2. FIG. 2 illustrates the viscosities of the treated Navy beans upon treatment with the amylase and the xylanase and treatment with the amylase. As can be seen in FIG. 2, treating the Navy beans with the combination of the two enzymes resulted in a product with a lower viscosity as compared to treatment with the xylanase alone.

### Example 3

Pre-cooked Navy beans were processed according to Example 2 using a xylanase enzyme, and a combination of an amylase enzyme and a xylanase enzyme. Both the xylanase treatment, and the treatment with both amylase and xylanase were able to make the 2-dp10+ oligosaccharides from the Navy beans increase and soluble, but not increase the total sugar content.

### Example 4

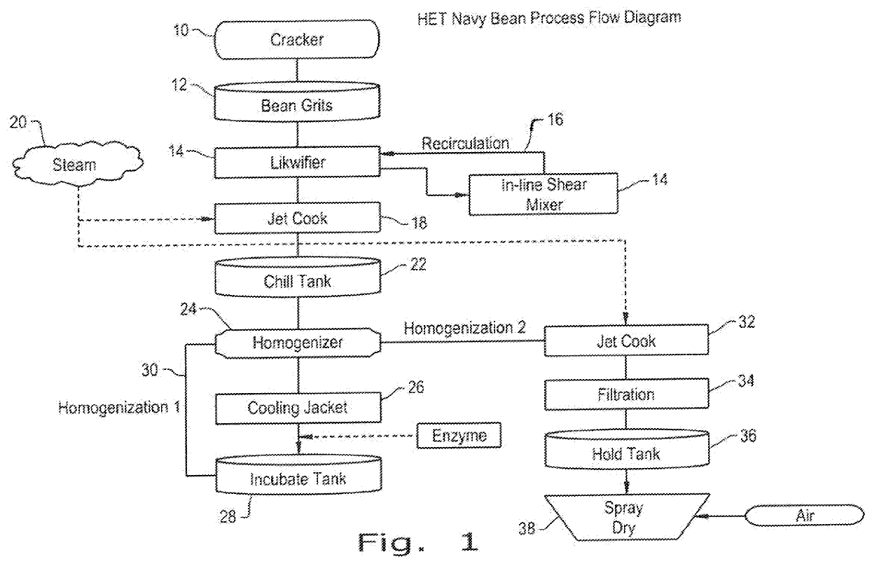

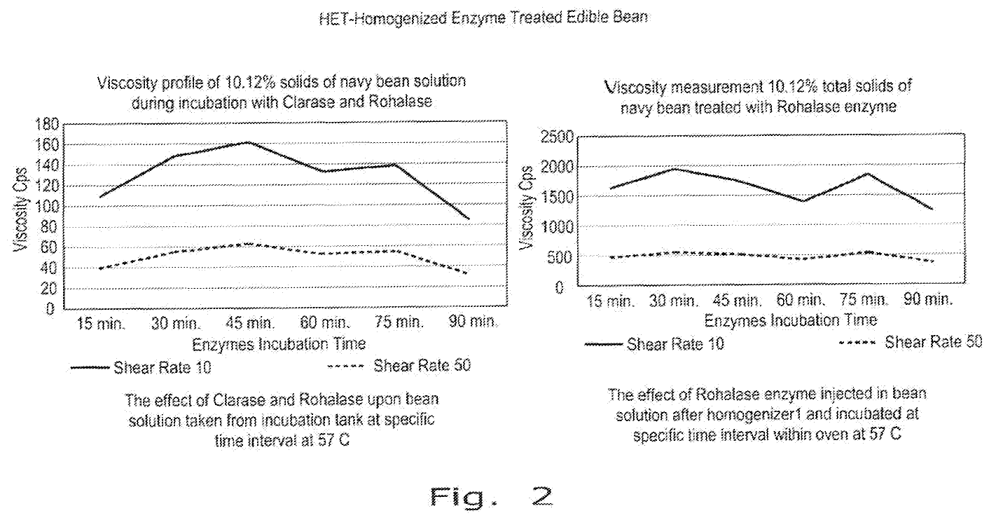

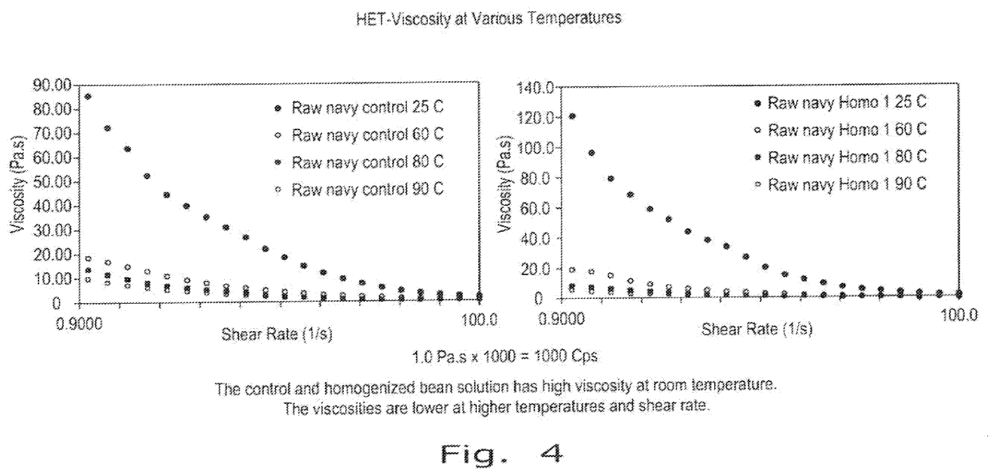

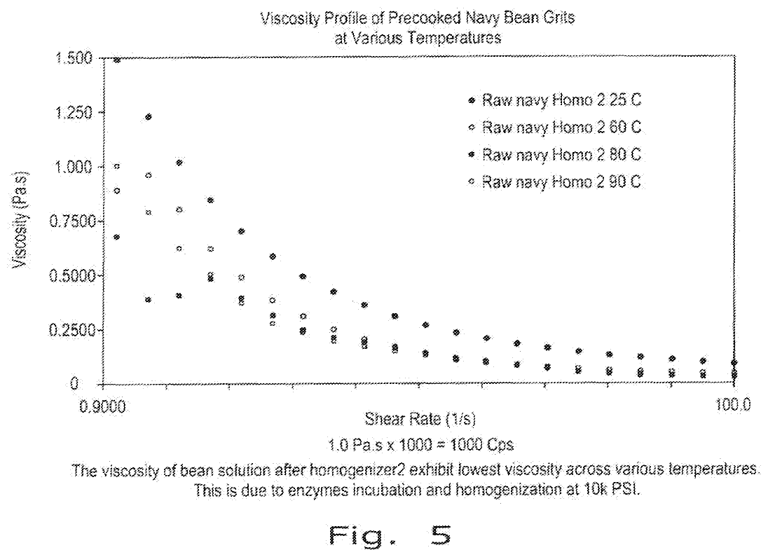

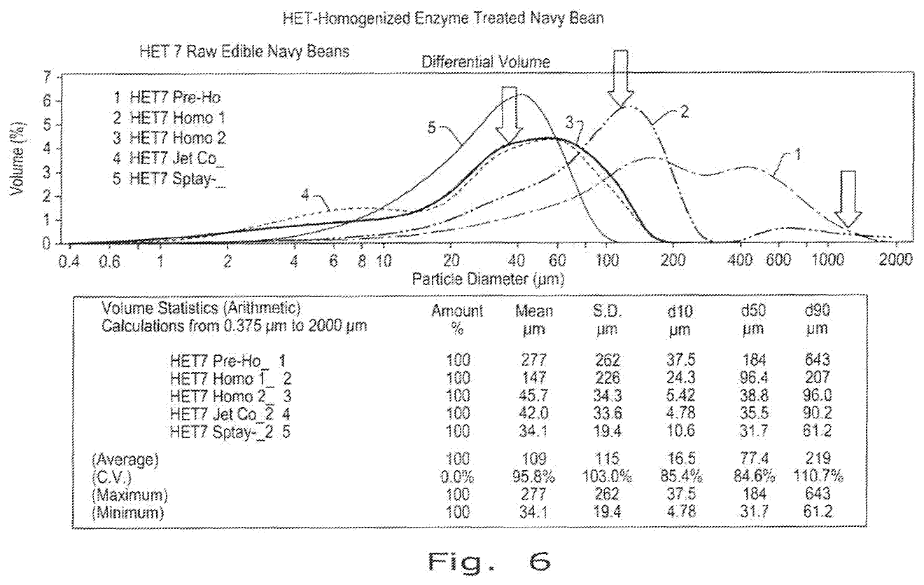

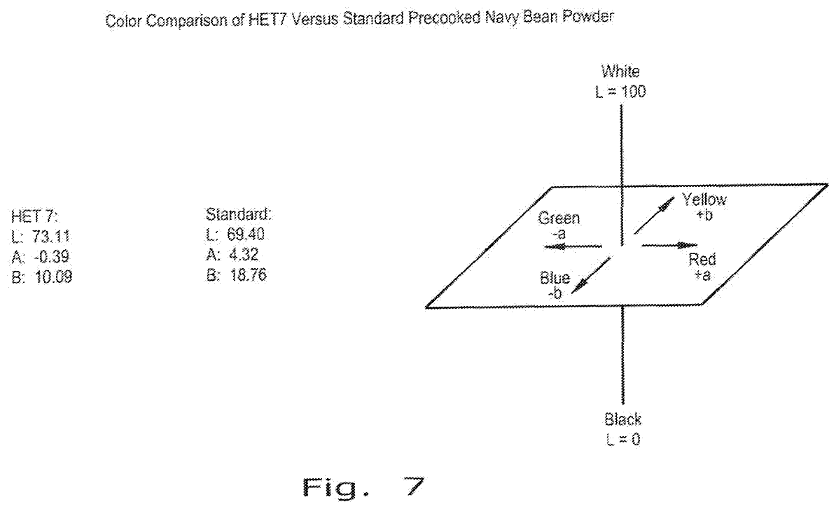

Samples were taken at various times of the process of Example 3 and viscosities were determined. FIG. 4 shows the viscosity of the raw, Navy bean product before homogenization (i.e., the control) and the viscosity of the raw, Navy bean product after the first homogenization of FIG. 1. The viscosities were determined at various temperatures. FIG. 5 shows the viscosity of the raw, Navy bean product after the second homogenization of FIG. 1. As can be seen from the graphs of FIGS. 4 and 5, the viscosity after the second homogenization and enzyme treatment reduces the viscosity of the raw, Navy bean product.

### Examples 5-7

For examples 5-7, a series of thickened liquids were prepared from agglomerated products to study and compare the effect of HET on viscosity and stability. Agglomerated products were prepared using a vector FLM-1 fluidized bed reactor. A bottom grid is used to distribute the hot air flow rate, to assure a good circulation of particles and drying of agglomerates. One fluid nozzle was used to spray the agglomeration liquid onto the core particles (20 PSI) water on the fluidized powder blends. The flow rates of spray solution and fluidizing air were adapted along the trials to maintain a good fluidization on the bed, to allow the formation of bridges between particles, and to keep the air temperature in the bed in the range of 26-80° C.

The viscosity and appearance of the thickened liquids were assessed using a

LV Brookfield viscometer at ambient temperature (25° C.) at 50 rpm, over a course of one hour, and with a #27 spindle that would represent the viscosity result within the proper torque range, as recommended by the National Dysphagia Diet Task Force.

Thickened liquids were prepared by by adding 1 g of agglomerated product described in Table 1 to 1 ounce of water in a 200 mL and dispersing the mixture by spoon for 15 seconds until no powder particles could be observed visually. After preparation, the viscosity of the dispersions were evaluated and then allowed to rest for 24 hours at ambient temperature. Viscosities were evaluated.

TABLE 1
Viscosity of thickened liquids of agglomerated products
comprising different ratios of HET to starch over time.

| | | | | | Viscosity | Viscosity | Viscosity | |
|---|---|---|---|---|---|---|---|---|
| | % | % | % | % | (cps) | (cps) | (cps) | |
| Example # | HET | Starch | Xanthan | Maltodextrin | 10 s | 1 hour | 24 hour | Consistency |
| 5 | 10 | 50 | 10 | 30 | 473 | 700 | 678 | honey |
| 6 | 20 | 40 | 10 | 30 | 337 | 532 | 516 | honey |
| 7 | 30 | 30 | 10 | 30 | 243 | 435 | 530 | honey |

Agglomeration conditions: 250 mL of spray solution; an inlet and outlet temperature of 33° C. and 26° C., respectively.

The viscosity of thickened liquids could be adjusted by adjusting the ratio of HET to starch in the agglomerated product. After the thickened liquids were allowed to rest for 24 hours at 20° C., the viscosity of the liquids within the range of viscosities given by the American National Diabetic Association, 2002, at a shear rate of 50 s⁻¹, showing that the compositions given in Table 1 formed stable thickened liquids.

Examples 8-10

In another series of experiments, the effects of agglomerated product concentration were examined. In the first series, an agglomerated product was prepared using a dry blend of HET:starch:xanthan:maltodextrin 40:45:5:10, with 220 mL of spray solution and an inlet temperature of 33° C. and outlet temperature of 26° C. Thickened liquids were prepared by adding different amounts of agglomerated product as shown in Table 2 to 1 ounce of water. The agglomerated product thickened liquids was mixed for 15 seconds at room temperature. The reference point was considered after the starch dispersed for 1 hour.

TABLE 2
Viscosity of thickened liquids comprising
different concentrations of agglomerated
products (HET:starch:xanthan:maltodextrin
40:45:5:10) over time.

| | Weight of | Vis- | Vis- | Vis- | |
|---|---|---|---|---|---|
| | agglomerated | cosity | cosity | cosity | |
| | product | (cps) | (cps) | (cps) | |
| Example # | (g) | 10 s | 1 h | 24 h | Consistency |
| 8 | 0.4 | 5 | 7 | 18 | thin |
| 9 | 0.6 | 13 | 21 | 45 | thin |
| 10 | 0.7 | 63 | 115 | 115 | nectar |

The results shown in Table 2 collectively indicate that the product viscosity and consistency can be influenced by a selection of the amount of agglomerated product in the thickened liquid. Thus, when the weight of agglomerated product was varied from 0.4 to 0.7 in 1 ounce of water, viscosity decreased from the thin consistency at 7 cps after 1 hour dispersion to 115 cps to the nectar consistency. All of the agglomerated products exhibited good dispersability. With respect to stability, all of the products retained viscosity after 24 hours.

### Examples 11-15

Subsequently, a series of further experiments was conducted using a different dry blend of HET:starch:xanthan:maltodextrin 40:40:10:10, prepared with 250 mL of spray solution and an inlet temperature of 33° C. and outlet temperature of 26° C. For the HET:starch:xanthan:maltodextrin 40:40:10:10 series, the weight of agglomerated product was varied from 0.1 to 1.0 in 1 ounce of water, for comparison of the viscosity and stability at different solids content. These results are shown in Table 3.

TABLE 3
Viscosity of thickened liquids comprising
different concentrations of agglomerated
products (HET:starch:xanthan:maltodextrin
40:40:10:10) over time.

| | Weight of | Vis- | Vis- | Vis- | |
|---|---|---|---|---|---|
| | agglomerated | cosity | cosity | cosity | |
| | product | (cps) | (cps) | (cps) | |
| Example # | (g) | 10 min | 1 h | 24 h | Consistency |
| 11 | 0.1 | 3 | 3 | 6 | Thin |
| 12 | 0.4 | 15 | 24 | 44 | Thin |
| 13 | 0.6 | 15 | 24 | 44 | Thin |
| 14 | 0.7 | 99 | 178 | 260 | Nectar-like |
| 15 | 1 | 362 | 528 | 570 | Honey-like |

In this series, HET:Starch:Xanthan:Maltodextrin 40:40:10:10, at various loadings of agglomerated product, different consistencies at a single shear rate of 50 s-1, the range of viscosities after 1 hour included products of thin, nectar-like and honey-like consistencies. Each of the thickened liquids using the composition of 40:40:10:10 HET:starch:xanthan:maltodextrin maintained stability after 24 hour. The newly formulated thickened liquids help to improve and maintain the safety and health of dysphagia patients by stabilizing the viscosity of thickened products and thereby reduce the risks associated with swallowing inconsistent food viscosities.

### Examples 16-17

For comparison, the viscosity of a composition of HET: starch:xanthan:maltodextrin and one commercially available product were evaluated for their ability to thicken and maintain viscosity in a ready-to-consume nutritional supplement, ENSURE. Dispersions for viscosity measurement were prepared with Ensure in a 4 ounce plastic condiment cup. ENSURE (1.0 ounce) was placed in the cup and then the thickening composition (0.5 g) was added to provide a thickened liquid. The dispersion was then added to the viscosity sample chamber using the standard sized plastic spoon, and the viscosity measurement was taken at 25° C. The remainder of the dispersion was stored in the capped 4 ounce plastic cup and placed in a refrigerator. Viscosity was evaluated after 24 hours. On the whole, the addition of the novel thickening composition to the nutritional supplement, ENSURE, provided a nutritional product of the present invention that outperformed the commercially available product. The novel composition maintained consistency and viscosity over 24 hours while the viscosity of the commercial product decreased significantly suggesting that the unique composition minimized the drawbacks of current commercial products. The results are shown in Table 4.

TABLE 4
Comparison of viscosity of thickened liquids in ENSURE
from agglomerated product (HET:starch:xanthan:maltodextrin
20:40:10:30) versus commercial product over time.

| | Vis- | Vis- | Vis- | Vis- |
|---|---|---|---|---|
| | cosity | cosity | cosity | cosity |
| | (cps) | (cps) | (cps) | (cps) |
| | 10 min | 30 min | 1 h | 24 h |
| HET:starch:xanthan:maltodextrin | 87 | 139 | 154 | 163 |
| (20:40:10:30) | | | | |
| Commercial | 90 | 116 | 143 | 82 |
| Product 1 | | | | |

### Examples 18-20

Due to the inherent drawbacks as described above with respect to the use of starch as a component of thickened liquids, further experiments were conducted without the addition of starch to the pulse product. Homogenized, enzyme treated, comminuted pulse products were prepared using the same conditions as disclosed in Examples 1-4 and then agglomerated with xanthan or maltodextrin or a combination thereof. As depicted in Table 5, the inventors surprisingly found that a combination of 90% HET with 10% xanthan gum on a dry basis results in a thickened liquid of nectar-like consistency. This novel composition provides a nutritional product high in protein and fiber without the addition of starch. Another thickened liquid was prepared to nectar consistency with an agglomerated product composition of HET:xanthan:maltodextrin 60:10:30. Yet, a HET based thickened liquid was prepared to thin consistency using a combination of HET and maltodextrin. Advantageously, these novel compositions are useful in providing nutrition to a patient suffering from dysphagia and even more suitable to those patients that must limit digestible carbohydrate consumption.

TABLE 5
Viscosity of thickened liquids of agglomerated products comprising
different ratios of HET, xanthan, and maltodextrin over time.

| | | | | Viscosity | Viscosity | |
|---|---|---|---|---|---|---|
| | HET | Xanthan | Maltodextrin | (cps) | (cps) | |
| Example # | (%) | (%) | (%) | 10 min | 1 h | Consistency |
| 18 | 90 | 10 | 0 | 52 | 154 | Nectar |
| 19 | 60 | 10 | 30 | 23 | 80 | Nectar |
| 20 | 80 | 0 | 20 | 21 | 23 | thin |

What is claimed is:

1. A method of treating a patient having dysphagia, the method comprising:
feeding a homogenized, comminuted pulse product to the patient having dysphagia.

2. The method of claim 1, wherein the pulse is selected from the group consisting of beans of Phaseolus species, beans of Vigna species, beans of Vicia species, peas, chickpeas, lentils, and combinations of any thereof.

3. The method of claim 1, further comprising incorporating the homogenized, comminuted pulse product into a nutritional supplement.

4. The method of claim 1, further comprising incorporating the homogenized, comminuted pulse product into a food product.

5. The method of claim 4, wherein the food product is selected from the group consisting of beverages, soup, batter, dips, and dairy products.

6. A method of providing nutrition to a patient suffering from dysphagia, the method comprising administering to the patient in need thereof a composition, comprising a homogenized, comminuted pulse product in combination with at least one hydrocolloid.

7. The method of claim 6, wherein the composition is agglomerated.

8. The method of claim 6, wherein the at least one hydrocolloid is selected from the group consisting of high-methylated pectin, low-methylated pectin, amidated pectin, hydroxyl methyl propyl cellulose, methyl cellulose, hydroxyl propyl cellulose, xanthan gum, agar, carrageenan, guar gum, alginate, carboxyl methyl cellulose, microcrystalline cellulose, starch, dextrin, maltodextrin, and combinations thereof.

9. The method of claim 6, wherein the composition comprises greater than 60 wt % homogenized, comminuted pulse product.

10. The method of claim 9, wherein the composition does not contain xanthan gum.

11. The method of claim 9, wherein the composition does not contain maltodextrin.

12. The method of claim 1, further comprising incorporating the homogenized, comminuted pulse product into a thickened liquid.

13. The method of claim 12, wherein the thickened liquid has a consistency selected from the group consisting of thin, nectar, honey, and spoon-thick liquid consistency.

14. A method of treating a patient having dysphagia, the method comprising:
feeding a homogenized, enzyme treated, comminuted pulse product to the patient having dysphagia.

15. A composition comprising from about 5 wt % to about 70 wt % homogenized, comminuted pulse product; from about 20 wt % to about 70 wt % starch; from about 5 wt % to about 40 wt % maltodextrin; and from about 2 wt % to about 30 wt % hydrocolloid.

16. The composition of claim 16 comprising from about 10 wt % to about 40 wt % homogenized, comminuted pulse product; from about 30 wt % to about 50 wt % starch; from about 10 wt % to about 30 wt % maltodextrin; and from about 5 wt % to about 10 wt % xanthan gum.

17. (canceled)

18. A method of providing nutrition to a patient suffering from dysphagia, the method comprising:
i. mixing a nutritional supplement with the composition of claim 15 and
ii. administering the resulting nutritional product to the dysphagia patient in need thereof.

19. The method of claim 18, wherein the homogenized, comminuted pulse product is enzyme treated.
